(19) United States
(12) Patent Application Publication
(10) Pub. No.: US 2026/0196017 A1
(43) Pub. Date: Jul. 9, 2026

(54) METHOD AND APPARATUS FOR REGION MATCHING IN ENVIRONMENT, ELECTRONIC DEVICE, COMPUTER-READABLE STORAGE MEDIUM, AND COMPUTER PROGRAM PRODUCT

(71) Applicant: UBTECH ROBOTICS CORP LTD, Shenzhen (CN)

(72) Inventors: XILAI SONG, Shenzhen (CN); Jichao Jiao, Shenzhen (CN)

(21) Appl. No.: 19/551,672

(22) Filed: Feb. 27, 2026

Related U.S. Application Data
(63) Continuation of application No. PCT/CN2024/143962, filed on Dec. 30, 2024.

(30) Foreign Application Priority Data
Jul. 25, 2024 (CN) 202411011214.9

(51) Int. Cl. G06V 10/75; G06T 7/73; G06V 10/762

(52) U.S. Cl. CPC G06V 10/759; G06T 7/74; G06V 10/751; G06V 10/762

(57) ABSTRACT

A method for region matching in an environment is provided, including: obtaining point set data of a target environment, where the point set data includes N data points; performing a first clustering process on the N data points to obtain M first clustering regions, where each first clustering region corresponds to a respective first clustering center, and each first clustering region includes P data points, where P≤N; determining, from the M first clustering regions, second clustering regions matched with pre-calibrated prior clustering regions; merging at least one first clustering region with the second clustering regions to obtain third clustering regions matched with the prior clustering regions; and using third clustering centers of the third clustering regions as clustering initial points to perform a second clustering process on the point set data to obtain first target clustering regions matched with the prior clustering regions.

### CROSS REFERENCE TO RELATED APPLICATIONS

The present application is a continuation of PCT Patent Application No. PCT/CN2024/143962, with an international filing date of Dec. 30, 2024, which claims priority to Chinese Patent Application No. 202411011214.9, filed on Jul. 25, 2024, each of which is incorporated by reference herein in its entirety.

### TECHNICAL FIELD

The present disclosure generally relates to the field of point set data processing technology, and more particularly, to a method and apparatus for region matching in an environment, an electronic device, a computer-readable storage medium, and a computer program product.

### BACKGROUND

When performing position matching between environmental data generated from an environment and actual objects within the environment, position offsets between the collected environmental data and expected positions of the actual objects readily occur due to limitations in hardware precision for acquiring the environmental data or software algorithms used during matching, resulting in inaccurate results in subsequent analysis.

### BRIEF DESCRIPTION OF DRAWINGS

FIG. 1 is a schematic architectural diagram illustrating a system for region matching in an environment according to an embodiment of the present disclosure.

FIG. 2 is a schematic structural diagram of an electronic device according to an embodiment of the present disclosure.

FIG. 3A is a schematic flowchart of a method for region matching in an environment according to an embodiment of the present disclosure.

FIG. 3B is a schematic flowchart of a method for pre-matching according to an embodiment of the present disclosure.

FIG. 3C is a schematic flowchart of a method for clustering region merging according to an embodiment of the present disclosure.

FIG. 4A is a schematic diagram of images to be observed in a target environment according to an embodiment of the present disclosure.

FIG. 4B is a schematic diagram of prior clustering regions calibrated corresponding to the images to be observed in the target environment according to an embodiment of the present disclosure.

FIG. 5A is a schematic diagram of initial eye movement data generated for the images to be observed according to an embodiment of the present disclosure.

FIG. 5B is a schematic diagram of eye movement data after position smoothing according to an embodiment of the present disclosure.

FIG. 6A is a first schematic diagram of clustering regions and clustering centers according to an embodiment of the present disclosure.

FIG. 6B is a first schematic diagram of expanded prior clustering regions, according to an embodiment of the present disclosure.

FIG. 7A is a second schematic diagram of clustering regions and clustering centers according to an embodiment of the present disclosure.

FIG. 7B is a second schematic diagram of expanded prior clustering regions according to an embodiment of the present disclosure.

FIG. 8 is a schematic diagram of target clustering regions according to an embodiment of the present disclosure.

FIG. 9 is a schematic scene diagram of the target environment according to an embodiment of the present disclosure.

It should be noted that the terms “first,” “second,” and the like as used above are merely intended to distinguish between different solutions, and do not indicate any superiority or inferiority between the solutions, nor any priority in the order of implementation.

### DETAILED DESCRIPTION

To make the objectives, technical solutions, and advantages of the present disclosure clearer, the following further describes the present disclosure in detail with reference to the accompanying drawings. The described embodiments should not be construed as limiting the present disclosure. All other embodiments obtained by a person of ordinary skills in the art based on the embodiments of the present disclosure without creative efforts shall fall within the protection scope of the present disclosure.

In the following description, reference is made to “some embodiments,” which describe a subset of all possible embodiments. However, it should be understood that “some embodiments” may be the same subset or different subsets of all possible embodiments and may be combined with each other without conflict.

In the following description, the terms “first,” “second,” “third,” etc., are used merely to distinguish similar objects and do not imply any specific ordering of the objects. It should be understood that, where permitted, “first,” “second,” “third,” etc., may be interchanged in a specific order or sequence, such that the embodiments of the present disclosure described herein may be implemented in an order other than that illustrated or described.

In the embodiments of the present disclosure, the term “module” or “unit” refers to a computer program or a part of the computer program with a predetermined function, which works in conjunction with other related parts to achieve predetermined objectives and can be implemented in whole or in part using software, hardware (such as processing circuit or memory), or a combination thereof. Similarly, one processor (or multiple processors or memory) may be used to implement one or more modules or units. Furthermore, each module or unit may be part of an integrated module or unit that encompasses the functions of that module or unit.

Unless otherwise defined, all technical and scientific terms used in the embodiments of the present disclosure have the same meanings as commonly understood by those skilled in the art. The terms used in the embodiments of the present disclosure are intended only to describe the embodiments of the present disclosure and are not intended to limit the present disclosure.

In the embodiments of the present disclosure, relevant data collection and processing shall, in practical applications, strictly comply with the requirements of applicable laws and regulations. This includes obtaining the informed consent or separate consent of the personal information subject and conducting subsequent data use and processing within the scope authorized by laws, regulations, and the personal information subject.

Before providing a further detailed description of the embodiments of the present disclosure, the following explains the nouns and terms involved in the embodiments of the present disclosure. The nouns and terms involved in the embodiments of the present disclosure are applicable to the following explanations.

1) Environmental data, i.e., data used to describe an environment. For example, environmental data may be eye movement data describing the environment from a gaze position perspective, two-dimensional image data describing the environment from a pixel color perspective (e.g., grayscale values of RGB channels), or three-dimensional image data describing the environment from a perspective of a combination of the color and pixel position. The three-dimensional image data may be point cloud data. Eye movement data, two-dimensional image data, and three-dimensional image data may all be considered as point set data. The point set data corresponding to eye movement data and two-dimensional image data is two-dimensional, whereas the point cloud data corresponding to three-dimensional image data is three-dimensional.

2) Eye movement data is a type of data collected through eye movement detection technology, which is able to reflect an individual's visual attention, gaze behavior, and cognitive processes. Eye movement detection technology is implemented by detecting and recording data such as eye movement trajectories, gaze points, gaze durations, and eye-movement paths.

Eye movement data includes at least gaze points. Gaze points record positions where a subject gazes on an observation plane, typically represented by pixel coordinates on a screen. Gaze points reflect focal positions of the subject's line of sight and may be used to analyze the distribution of the subject's visual attention.

3) Clustering is an unsupervised learning method primarily used for data mining and statistical data analysis. A fundamental objective of clustering is to classify a set of data. Unlike conventional classification methods, clustering analysis is performed without prior knowledge of data categories. The result of clustering is partitioning of data into several clusters (i.e., clustering regions in the present disclosure), such that data points within the same cluster exhibit a high degree of similarity to each other, while data points in different clusters exhibit a low degree of similarity.

When performing position matching between environmental data generated from an environment and actual objects within the environment, position offsets between the collected environmental data and expected positions of the actual objects may readily occur due to limitations in hardware precision for acquiring the environmental data or software algorithms used during matching. For example, when using an eye tracker device to obtain a viewing region and position of human eyes, a situation may arise, if the hardware and software algorithms of the eye tracker cannot be properly calibrated, where the human eyes are actually viewing region A, but the in data acquired by the eye tracker indicates that the human eyes are viewing region B. This may lead to inaccuracies in subsequent analysis results.

Embodiments of the present disclosure provide a method and apparatus for region matching in an environment, an electronic device, a computer-readable storage medium, and a computer program product, which improve the accuracy of region matching in the environment.

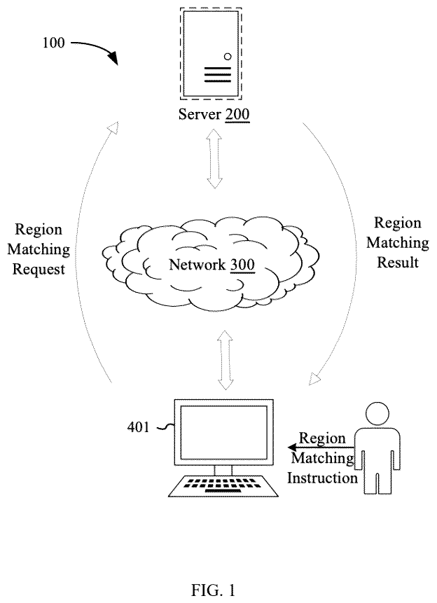

Referring to FIG. 1, FIG. 1 is a schematic architectural diagram of a region matching system 100 in an environment according to an embodiment of the present disclosure. To support a region matching application in an environment, a terminal 401 is connected to a server 200 via a network 300. The network 300 may be a wide area network, a local area network, or a combination thereof.

The terminal 401 is configured to transmit a request for region matching in an environment to the server 200 in response to an instruction for region matching in the environment.

The server 200 is configured to, when receiving the request for region matching in the environment, obtain point set data of a target environment in response to the request for region matching in the environment; perform a first clustering process on N data points in the point set data to obtain M first clustering regions, where each of the M first clustering regions corresponds to a respective first clustering center, and each of the M first clustering regions includes P data points, where N, M, and P are positive integers and PLN; determine, from the M first clustering regions, second clustering regions matched with prior clustering regions that are pre-calibrated; merge at least one of the M first clustering regions with the second clustering regions to obtain third clustering regions matched with the prior clustering regions; and use third clustering centers of the third clustering regions as clustering initial points to perform a second clustering process on the point set data to obtain first target clustering regions matched with the prior clustering regions; and determine a region matching result for the target environment and transmit the region matching result to the terminal 401.

In some embodiments, the method for region matching in the environment provided in an embodiment of the present disclosure may be implemented by various electronic devices, e.g., may be implemented solely by the terminal 401, solely by the server 200, or collaboratively by the terminal 401 and the server 200.

In some embodiments, the terminal 401 may be implemented as various types of terminals, such as a laptop computer, tablet computer, desktop computer, set-top box, smartphone, smart speaker, smartwatch, smart TV, in-vehicle terminal, or the like.

In some embodiments, the server 200 may be an independent physical server, a server cluster or distributed system composed of a plurality of physical servers, or a cloud server providing fundamental cloud computing services such as cloud services, cloud databases, cloud computing, cloud functions, cloud storage, network services, cloud communication, middleware services, domain name services, security services, content delivery network (CDN), as well as big data and artificial intelligence platforms. The terminal and the server may be connected directly or indirectly via wired or wireless communication means, which is not limited in the embodiments of the present disclosure.

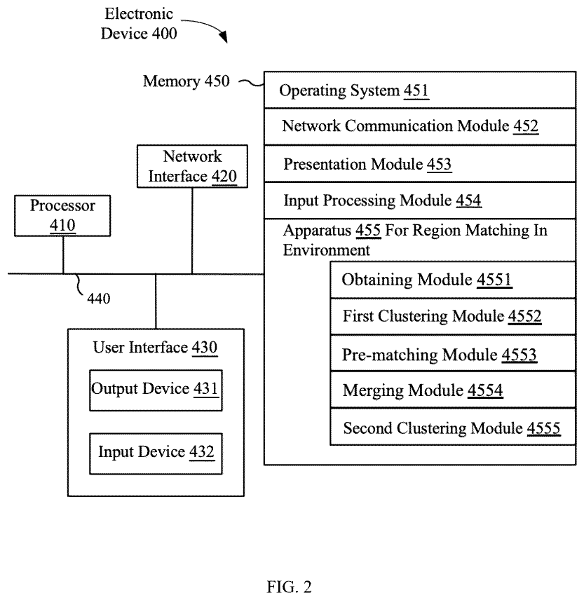

Referring to FIG. 2, FIG. 2 is a schematic structural diagram of an electronic device 400 according to an embodiment of the present disclosure. The electronic device 400 shown in FIG. 2 includes at least one processor 410, a memory 450, at least one network interface 420, a user interface 430. Components of the electronic device 400 are coupled together via a bus system 440. It should be understood that the bus system 440 is configured to implement connection and communication between these components. The bus system 440 includes not only a data bus but also a power bus, a control bus, and a status signal bus. However, for clarity of illustration, all buses are labeled as the bus system 440 in FIG. 2.

The processor 410 may be an integrated circuit chip with signal processing capabilities, such as a general-purpose processor, a digital signal processor (DSP), or other programmable logic devices, discrete gate or transistor logic devices, discrete hardware components, etc. The general-purpose processor may be a microprocessor or any conventional processor.

The user interface 430 includes one or more output devices 431 capable of presentation of media content, including one or more speakers and/or one or more visual display screens. The user interface 430 further includes one or more input devices 432, including user interface components facilitating user input, such as a keyboard, a mouse, a microphone, a touch-screen display, a camera, and other input buttons and controls.

The memory 450 may be removable, non-removable, or a combination thereof. Exemplary hardware devices include solid-state memory, hard disk drives, optical disk drives, etc. The memory 450 optionally includes one or more storage devices physically located away from the processor 410.

The memory 450 includes volatile memory or non-volatile memory, or may include both volatile and non-volatile memory. Non-volatile memory may be read-only memory (ROM), and volatile memory may be random access memory (RAM). The memory 450 described in the embodiments of the present disclosure is intended to include any suitable type of memory.

In some embodiments, the memory 450 is capable of storing data to support various operations. Examples of such data include programs, modules, data structures, or a subset or superset thereof, as exemplarily described below.

An operating system 451, including system programs for handling various basic system services and performing hardware-related tasks, such as a framework layer, a core library layer, a driver layer, etc., is used to implement various basic services and handle hardware-based tasks.

A network communication module 452 is configured to reach other electronic devices via one or more (wired or wireless) network interfaces 420. Exemplary network interfaces 420 include Bluetooth, Wireless Fidelity (WiFi), and universal serial bus (USB), etc.

A presentation module 453 is configured to enable presentation of information (e.g., for operating peripheral devices and user interfaces displaying content and information) via one or more output devices 431 (e.g., a display, a loudspeaker, etc.) associated with one or more user interfaces 430.

An input processing module 454 is configured to detect one or more user inputs or interactions from one of one or more input devices 432, and to translate the detected inputs or interactions.

In some embodiments of the present disclosure, an apparatus for region matching in an environment is implemented in software. FIG. 2 illustrates the apparatus 455 for region matching in the environment stored in memory 450. The apparatus 455 for region matching in the environment may be implemented as software in the form of programs, plug-ins, or the like, and includes the following software modules: an obtaining module 4551, a first clustering module 4552, a pre-matching module 4553, a merging module 4554, and a second clustering module 4555. These modules are logical modules and therefore may be arbitrarily combined or further divided according to the functions to be implemented. The functions of each module are described below.

In other embodiments of the present disclosure, the apparatus for region matching in the environment is implemented in hardware. As an example, the apparatus for region matching in the environment provided in embodiments of the present disclosure may be implemented as a processor in the form of a hardware decoding processor that is programmed to execute the method for region matching in the environment as provided in the embodiments of the present disclosure. For example, the processor in the form of the hardware decoding processor may be implemented using one or more application specific integrated circuits (ASICs), digital signal processors (DSPs), programmable logic devices (PLDs), complex programmable logic devices (CPLDs), field-programmable gate arrays (FPGAs), or other electronic components.

The following describes the method for region matching in the environment provided in the embodiments of the present disclosure with reference to the accompanying drawings. As described above, an electronic device configured to implement the method for region matching in the environment in the embodiments of the present disclosure may be the terminal 401, the server 200, or a combination thereof. Therefore, the execution entity of each operation is not repeatedly described below.

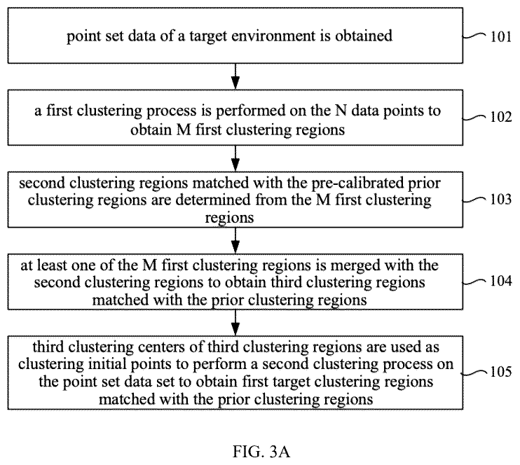

As an example, the following description of the method for region matching in the environment according to embodiments of the present disclosure is made with reference to the server 200 as the execution entity. Referring to FIG. 3A, FIG. 3A is a first schematic flowchart of the method for region matching in the environment according to an embodiment of the present disclosure. The method is described in conjunction with operations shown in FIG. 3A.

At operation 101, point set data of a target environment is obtained.

The point set data includes N data points.

In embodiments of the present disclosure, when the point set data is represented as eye movement data or three-dimensional image data, each data point in the point set data has corresponding position information and timing information. When the point set data is represented as eye movement data, the position information of the data point may be two-dimensional coordinates. When the point set data is represented as three-dimensional image data, the position information of the data point may be three-dimensional coordinates. When the point set data is represented as two-dimensional image data, the data point may have pixel information or depth information.

As an example, when the target environment is represented as a scenario in which an observation subject views image information or text information displayed on a screen of an electronic device from a viewing position, point set data of the target environment may be eye movement data collected by an eye tracker when the observation subject views the screen from the viewing position.

In some embodiments, operation 101 shown in FIG. 3A may be implemented as follows.

Initial point set data generated for the target environment is obtained, where the initial point set data includes N initial data points. Position smoothing is performed on the N initial data points in the initial point set data to obtain point set data.

When the initial point set data (e.g., initial eye movement data) for the target environment is collected by a hardware device (e.g., an eye tracker), the initial point set data typically exhibits certain jitter due to limitations in device accuracy. Therefore, after initial point set data generated for the target environment is obtained, position smoothing may first be performed on the data points in the initial point set data, that is, a de-jittering process is performed on the initial point set data.

In practical implementations, position smoothing may be performed for each initial data point based on timing sequences of the N initial data points in the initial point set data, so as to obtain position-smoothed point set data.

In some embodiments, the operation of “performing position smoothing on the N initial data points in the initial point set data to obtain the point set data” may be implemented as follows.

Based on timing information of each initial data point, the N initial data points are sorted. For each initial data point, the following operations are performed: R surrounding data points associated with the initial data point are determined based on a result of the sorting, where a timing difference between each surrounding data point and the initial data point is less than a preset threshold; among the R surrounding data points, n surrounding data points that have been subjected to position smoothing and m surrounding data points that have not been subjected to position smoothing are determined, where R, m, and n are integers and m=R−n; first initial position information of the initial data point, second initial position information of the m surrounding data points, and first updated position information of the n surrounding data points are obtained; position smoothing is performed on the initial data point based on the first initial position information, the second initial position information of the m surrounding data points, and the first updated position information of the n surrounding data points to obtain second updated position information of the initial data point; and second updated position information of each initial data point in the initial point set data is used as position information of each data point in the point set data.

The timing difference between the surrounding data point and the initial data point is less than the preset threshold, and the preset threshold may be configured according to actual smoothing requirements in practical implementations. If, in a practical implementation, it is desired to use a relatively large number of surrounding data points to perform position smoothing for the current initial data point, the value of the preset threshold may be set relatively large. Conversely, if it is not desired to use a large number of surrounding data points to perform position smoothing for the current initial data point, the value of the preset threshold may be set relatively small.

As an example, if five surrounding data points are to be used to perform position smoothing for an initial data point, the preset threshold may be set to 6. If the initial point set data includes 100 initial data points, any five data points whose timing sequence numbers fall within the range from 5 to 15 may be selected as the surrounding data points for the initial data point having a timing sequence number of 10.

In some embodiments, determining the R surrounding data points associated with the initial data point based on the sorting result may include the following cases. That is, when a timing sequence number of the initial data point is greater than a first specified sequence number, R surrounding data points that are adjacent to and precede the initial data point are determined based on the sorting result; when the timing sequence number of the initial data point is greater than a second specified sequence number and less than or equal to the first specified sequence number, n surrounding data points that are adjacent to and precede the initial data point and m surrounding data points that are adjacent to and follow the initial data point are determined based on the sorting result; and when the timing sequence number of the initial data point is equal to the second specified sequence number, R surrounding data points that are adjacent to and follow the initial data point are determined based on the sorting result.

In practical implementations, the respective initial data points may be subjected to position smoothing in ascending order of their timing sequence numbers based on the sorting result. Because the position information of the initial data point after completion of position smoothing more accurately reflects the true position, when selecting the R surrounding data points for the current initial data point, surrounding data points whose timing sequence numbers precede that of the current initial data point are preferably used. However, when the current initial data point is relatively early in the sequence, that is, when the timing sequence number of the current initial data point is relatively small, the number of surrounding data points preceding the current initial data point may be less than R. In this case, surrounding data points following the current initial data point may also be selected. Accordingly, embodiments of the present disclosure provide the first specified sequence number and the second specified sequence number. The manner of determining the R surrounding data points of the initial data point is determined according to the relationship between the timing sequence number of the initial data point and the first and second specified sequence numbers. Typically, the second specified sequence number is the minimum timing sequence number among the timing sequence numbers of the N initial data points, and the first specified sequence number may be set according to the preset threshold described above.

As an example, if three surrounding data points are to be used to perform position smoothing for an initial data point, the preset threshold may be set to 4, that is, the difference between the timing sequence number of each surrounding data point and that of the initial data point should be less than 4. In this case, if, after timing sequence sorting, the N initial data points are assigned consecutive positive integers starting from 1 as their timing sequence numbers, the first specified sequence number may be set to 3 and the second specified sequence number may be set to 1. According to the relationship between the timing sequence number of the initial data point and the first and second specified sequence numbers, the following cases may be included. That is, when the timing sequence number of the initial data point is greater than 3, three surrounding data points that are adjacent to and precede the initial data point may be determined based on the sorting result; when the timing sequence number of the initial data point is greater than 1 and less than or equal to 3, all surrounding data points that are adjacent to and precede the initial data point (i.e., n surrounding data points, all of which have been subjected to position smoothing) may first be determined, and then m surrounding data points that are adjacent to and follow the initial data point may be determined (m=3−n, and these m surrounding data points have not yet been subjected to position smoothing); and when the timing sequence number of the initial data point is equal to 1, three surrounding data points that are adjacent to and follow the initial data point may be determined as the surrounding data points associated with the initial data point.

As an example, when the timing sequence number of the initial data point is 6, the three surrounding data points associated with this initial data point may be determined as the surrounding data points having timing sequence numbers of 5, 4, and 3. When the timing sequence number of the initial data point is 3, two surrounding data points preceding this initial data point (i.e., the surrounding data points having timing sequence numbers of 2 and 1) are first determined, and then one surrounding data point following this initial data point (i.e., the surrounding data point having a timing sequence number of 4) is determined; the three surrounding data points having timing sequence numbers of 1, 2, and 4 are used as the surrounding data points associated with this initial data point. When the timing sequence number of the initial data point is 1, the three surrounding data points having timing sequence numbers of 2, 3, and 4 that follow this initial data point may be determined as the surrounding data points associated with this initial data point.

After determining the R surrounding data points associated with the current initial data point, n surrounding data points among the R surrounding data points that have been subjected to position smoothing and m surrounding data points that have not been subjected to position smoothing are determined. The current initial data point is then subjected to position smoothing using the first updated position information obtained by the n surrounding data points after completion of position smoothing, the second initial position information corresponding to the m surrounding data points, and the first initial position information corresponding to the current initial data point.

In some embodiments, the operation of “performing position smoothing on the initial data point based on the first initial position information, the second initial position information of the m surrounding data points, and the first updated position information of the n surrounding data points to obtain second updated position information of the initial data point” may be implemented as follows.

A first weight corresponding to the first initial position information, a second weight corresponding to the second initial position information of the m surrounding data points, and a third weight corresponding to the first updated position information of the n surrounding data points are obtained, where the first weight is greater than the second weight, and the third weight is greater than the second weight. Based on the first weight, the second weight, and the third weight, a weighted summation is performed on the first initial position information, the second initial position information of the m surrounding data points, and the first updated position information of the n surrounding data points to obtain the second updated position information of the initial data point.

In practical implementations, different weights may be assigned to different data when performing position smoothing for the initial data point so as to improve the accuracy of the position smoothing. Specifically, the weights may be assigned such that: the weight corresponding to the first initial position information of the initial data point before position smoothing is the largest; among the R related surrounding data points, the weight corresponding to the first updated position information of the n surrounding data points after position smoothing is greater than the weight corresponding to the second initial position information of the m surrounding data points before position smoothing; and, among the n surrounding data points, the weight corresponding to the first updated position information of a surrounding data point increases as its timing sequence number becomes closer to that of the initial data point. In this way, corresponding weights are assigned to the first initial position information, the second initial position information of the m surrounding data points, and the first updated position information of the n surrounding data points. The first weight is assigned to the first initial position information, the second weight is assigned to the second initial position information of the m surrounding data points, and the third weight is assigned to the first updated position information of the n surrounding data points, with the first weight being greater than the second weight and the third weight being greater than the second weight.

As an example, when performing position smoothing for an initial data point having a timing sequence number of 2, three surrounding data points associated with this initial data point are determined as the surrounding data points having timing sequence numbers of 1, 3, and 4. Among them, the surrounding data point having a timing sequence number of 1 has been subjected to position smoothing, while the surrounding data points having timing sequence numbers of 3 and 4 have not yet been subjected to position smoothing. The first initial position information corresponding to the initial data point, the second initial position information of the surrounding data point with a timing sequence number of 3, the second initial position information of the surrounding data point with a timing sequence number of 4, and the first updated position information corresponding to the surrounding data point with a timing sequence number of 1 are obtained. Then, a maximum weight of 0.4 (the first weight) is assigned to the first initial position information of the initial data point, a weight of 0.3 (the third weight) is assigned to the first updated position information of the surrounding data point with a timing sequence number of 1, and, because the surrounding data point with a timing sequence number of 3 is closer in sequence to the initial data point than the surrounding data point with a timing sequence number of 4, a weight of 0.2 is assigned to the second initial position information of the surrounding data point with a timing sequence number of 3, and a weight of 0.1 is assigned to the second initial position information of the surrounding data point with a timing sequence number of 4. The two weights corresponding to the second initial position information are the second weights. Overall, the first weight is greater than the second weights, and the third weight is greater than the second weights.

In some embodiments, the operation of “performing the weighted summation on the first initial position information, the second initial position information of the m surrounding data points, and the first updated position information of the n surrounding data points based on the first weight, the second weight, and the third weight to obtain the second updated position information of the initial data point” may be implemented as follows.

A first product value between the first initial position information and the first weight, a second product value between the second initial position information and the corresponding second weight, and a third product value between the first updated position information and the corresponding third weight are determined. Based on a sum of the first product value, the second product value, and the third product value, the second updated position information of the initial data point having been subjected to position smoothing is determined.

As an example, the initial point set data includes N=100 initial data points. After the 100 initial data points are sorted according to timing sequence information, the timing sequence numbers of the 100 initial data points are 1 to 100. The preset threshold is set to 4, the first specified sequence number is 3, and the second specified sequence number is 1, and three surrounding data points are used to perform position smoothing for each initial data point. The initial data points may be subjected to position smoothing in ascending order of their timing sequence numbers.

For the initial data point having a timing sequence number n=1 (i.e., a first frame initial data point), a weighted summation is performed on first initial position information of the first frame initial data point before updating (i.e., before position smoothing), second initial position information of a second frame initial data point (i.e., a surrounding data point with a timing sequence number of 2) before updating, second initial position information of a third frame initial data point (i.e., a surrounding data point with a timing sequence number of 3) before updating, and second initial position information of a fourth frame initial data point (i.e., a surrounding data point with a timing sequence number of 4) before updating, and future data is used to perform position smoothing for the first frame initial data point. Specifically, second updated position information of the first frame initial data point may be calculated using the following equation:

$${P}_{1}^{new} = 0.4 * {P}_{1}^{old} + 0.3 * {P}_{2}^{old} + 0.2 * {P}_{3}^{old} + 0.1 * {P}_{4}^{old}$$

where P represents an initial data point. The subscript to the lower right of P denotes the timing sequence number of the initial data point, and the superscript to the upper right of P denotes whether pre-update data or post-update data (i.e., data before position smoothing or data after position smoothing) of this initial data point is used. The superscript “new” indicates post-update data, and the superscript “old” indicates pre-update data.

$${P}_{1}^{new}$$

represents the second updated position information of the initial data point having a timing sequence number of 1,

$${P}_{1}^{old}$$

represents the first initial position information (corresponding to a first weight of 0.4) of the initial data point having a timing sequence number of 1,

$${P}_{2}^{old}$$

represents the second initial position information (corresponding to a second weight of 0.3) of the initial data point having a timing sequence number of 2,

$${P}_{3}^{old}$$

represents the second initial position information (corresponding to a second weight of 0.2) of the initial data point having a timing sequence number of 3, and

$${P}_{4}^{old}$$

represents the second initial position information (corresponding to a second weight of 0.1) of the initial data point having a timing sequence number of 4.

For the initial data point having a timing sequence number n=2 (i.e., the second frame initial data point), the second updated position information of the second frame initial data point after updating is obtained by performing a weighted summation on the first initial position information of the second frame initial data point before updating, the first updated position information of the first frame initial data point after updating, and the second initial position information of the third frame and fourth frame initial data points before updating, and both future data and past data are used to perform position smoothing for the second frame initial data point. Specifically, the second updated position information of the second frame initial data point may be calculated using the following equation:

$${P}_{2}^{new} = 0.3 * {P}_{1}^{new} + 0.4 * {P}_{2}^{old} + 0.2 * {P}_{3}^{old} + 0.1 * {P}_{4}^{old}$$

where

$${P}_{2}^{new}$$

represents the second updated position information of the initial data point having a timing sequence number of 2;

$${P}_{1}^{new}$$

represents the first updated position information (corresponding to a third weight of 0.3) of the initial data point having a timing sequence number of 1;

$${P}_{2}^{old}$$

represents the first initial position information (corresponding to a first weight of 0.4) of the initial data point having a timing sequence number of 2;

$${P}_{3}^{old}$$

represents the second initial position information (corresponding to a second weight of 0.2) of the initial data point having a timing sequence number of 3; and

$${P}_{4}^{old}$$

represents the second initial position information (corresponding to a second weight of 0.1) of the initial data point having a timing sequence number of 4.

For the initial data point having a timing sequence number n=3 (i.e., the third frame initial data point), the second updated position information of the third frame initial data point after updating is obtained by performing a weighted summation on the first updated position information of the first frame initial data point after updating, the first updated position information of the second frame initial data point after updating, the first initial position information of the third frame initial data point before updating, and the second initial position information of the fourth frame initial data point before updating, and both future data and past data are used to perform position smoothing for the third frame initial data point. Specifically, the second updated position information of the third frame initial data point may be calculated using the following equation:

$${P}_{3}^{new} = 0.2 * {P}_{1}^{new} + 0.3 * {P}_{2}^{new} + 0.4 * {P}_{3}^{old} + 0.1 * {P}_{4}^{old}$$

where

$${P}_{3}^{new}$$

represents the second updated position information of the initial data point having a timing sequence number of 3;

$${P}_{1}^{new}$$

represents the first updated position information (corresponding to a third weight of 0.2) of the initial data point having a timing sequence number of 1;

$${P}_{2}^{new}$$

represents the first updated position information (corresponding to a third weight of 0.3) of the initial data point having a timing sequence number of 2;

$${P}_{3}^{old}$$

represents the first initial position information (corresponding to a first weight of 0.4) of the initial data point having a timing sequence number of 3; and

$${P}_{4}^{old}$$

represents the second initial position information (corresponding to a second weight of 0.1) of the initial data point having a timing sequence number of 4.

For an initial data point having a timing sequence number greater than 3 (n>3), for example, an initial data point having a timing sequence number n=24, the second updated position information of the 24^{th} frame initial data point is obtained by performing a weighted summation on the first updated position information of the 21^{th} frame, 22^{th} frame, and 23^{th} frame initial data points after updating, and the first initial position information of the 24^{th} frame initial data point before updating, and past data is used to perform position smoothing for the 24^{th} frame initial data point. Specifically, the second updated position information of the 24^{th} frame initial data point may be calculated using the following equation:

$${P}_{24}^{new} = 0.1 * {P}_{21}^{new} + 0.2 * {P}_{22}^{new} + 0.3 * {P}_{23}^{new} + 0.4 * {P}_{24}^{old}$$

where

$${P}_{24}^{new}$$

represents the second updated position information of the initial data point having a timing sequence number of 24;

$${P}_{21}^{new}$$

represents the first updated position information (corresponding to a third weight of 0.1) of the initial data point having a timing sequence number of 21;

$${P}_{22}^{new}$$

represents the first updated position information (corresponding to a third weight of 0.2) of the initial data point having a timing sequence number of 22;

$${P}_{23}^{new}$$

represents the first updated position information (corresponding to a third weight of 0.3) of the initial data point having a timing sequence number of 23; and

$${P}_{24}^{old}$$

represents the first initial position information (corresponding to a first weight of 0.4) of the initial data point having a timing sequence number of 24.

In addition, because the point set data in the embodiments of the present disclosure includes position information, and each data point is generally represented by coordinate values (x, y), in actual computation of the second updated position information of an initial data point, an updated value of the x-coordinate is computed using the relevant data for the x-coordinate, and an updated value of the y-coordinate is computed using the relevant data for the y-coordinate, respectively.

After the second updated position information corresponding to each initial data point in the initial point set data is obtained by the above method, the second updated position information of each initial data point in the initial point set data is used as the position information of each corresponding data point in point set data, thereby obtaining the point set data.

Continuing to refer to FIG. 3A, the description proceeds with operation 101 as discussed above.

At operation 102, a first clustering process is performed on the N data points to obtain M first clustering regions.

Each first clustering region corresponds to a respective first clustering center, and the respective first clustering center is the center of the first clustering region. Each first clustering region includes P data points, where N, M, and P are positive integers, and P≤N.

In some embodiments, operation 102 may be implemented as follows. The first clustering process is performed on the N data points in the point set data by using prior clustering centers of prior clustering regions as clustering initial points, so as to obtain the M first clustering regions; or, the first clustering process is performed on the N data points in the point set data by using the number of prior clustering regions as the number of clustering regions, so as to obtain the M first clustering regions, where M is equal to the number of the prior clustering regions.

In embodiments of the present disclosure, the prior clustering regions are regions that are pre-calibrated for a specified object in a target environment.

As an example, when the target environment is represented as a scenario in which an observation subject views image information or text information displayed on a screen of an electronic device from a viewing position, and the point set data of the target environment is eye movement data acquired by an eye tracker while the observation subject views the screen from the viewing position, the specified object may be the image information or the text information on the screen.

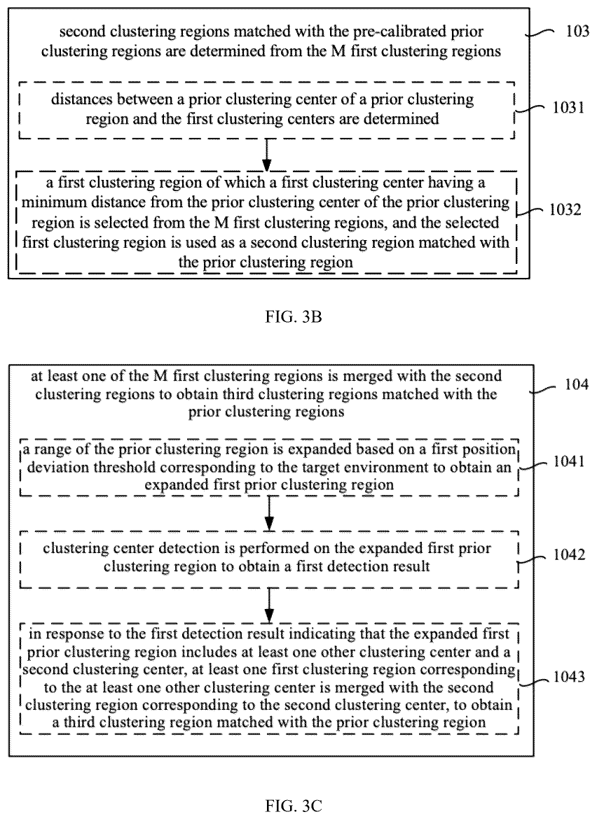

As an example, refer to FIG. 4A. FIG. 4A illustrates an image presented to the observation subject on the screen of the electronic device, including specified object 501, specified object 502, specified object 503, and specified object 504. Corresponding prior clustering regions are pre-calibrated for the four specified objects in the image of FIG. 4A. As shown in FIG. 4B, the prior clustering regions are represented by rectangular regions. Four rectangular regions are used in the image to respectively mark the positions of the four specified objects, i.e., prior clustering region 5011 corresponds to the position of specified object 501 in the image shown in FIG. 4A, prior clustering region 5021 corresponds to the position of specified object 502 in the image, prior clustering region 5031 corresponds to the position of specified object 503 in the image, and prior clustering region 5041 corresponds to the position of specified object 504 in the image.

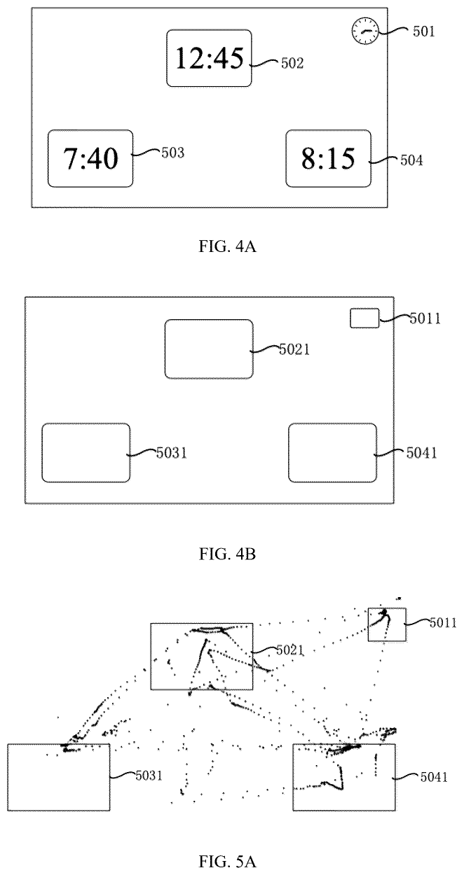

As an example, refer to FIG. 5A. FIG. 5A illustrates initial eye movement data (i.e., the initial point set data) collected when the observation subject views the image shown in FIG. 4A. As can be seen from FIG. 5A, the observation subject gazes at specified object 503, but the acquired initial eye movement data is overall shifted upward, such that some eye movement data points fall outside prior clustering region 5031. After the initial eye movement data points in FIG. 5A are subjected to the position smoothing process as described in the above embodiments, smoothed eye movement data (serving as the point set data) as shown in FIG. 5B is obtained. Compared with FIG. 5A, the jitter of the eye movement data in FIG. 5B is significantly reduced, and the eye movement trajectory is clearly observed. However, as can be seen from FIG. 5B, the smoothed eye movement data still exhibit a position offset with respect to prior clustering region 5031. Accordingly, in order to enable position matching between data points in the eye movement data and the corresponding prior clustering regions, the first clustering process is first performed on the N data points in the eye movement data to obtain M first clustering regions, with each first clustering region including P eye movement data points. Then, the position matching is performed between the first clustering regions and the prior clustering regions.

As an example, since the clustering of the point set data is performed for the purpose of matching with the prior clustering regions, the prior clustering centers of the prior clustering regions may be directly used as clustering initial points for the first clustering process to perform the first clustering process on the N data points in the point set data so as to obtain the M first clustering regions. In this case, the number of first clustering regions is typically equal to the number of prior clustering regions.

As an example, the number of prior clustering regions may also be directly used as the number of clustering regions, such that, after the first clustering process is performed on the N data points in the point set data, the first clustering regions are obtained whose number is equal to the number of prior clustering regions.

As an example, it is also possible to perform the first clustering process without specifying the number of clustering regions or the clustering initial points. Instead, given a distance condition required for clustering, random clustering is performed on the point set data to obtain the M first clustering regions. In this case, M is a random value.

At operation 103, second clustering regions matched with the pre-calibrated prior clustering regions are determined from the M first clustering regions.

In some embodiments, with reference to FIG. 3B, operation 103 may be implemented through operations 1031 and 1032 as follows. Operations 1031 and 1032 are described from the perspective of each individual prior clustering region.

At operation 1031, distances between a prior clustering center of a prior clustering region and the first clustering centers are determined.

At operation 1032, a first clustering region of which a first clustering center having a minimum distance from the prior clustering center of the prior clustering region is selected from the M first clustering regions, and the selected first clustering region is used as a second clustering region matched with the prior clustering region.

In embodiments of the present disclosure, the prior clustering centers are the centers of the prior clustering regions.

In practical implementations, a first clustering region may be preliminarily matched to a prior clustering region based on the distance between the prior clustering center and the first clustering centers. Specifically, prior clustering centers corresponding to respective prior clustering regions and first clustering centers corresponding to respective first clustering regions are determined; distances between a respective one of the prior clustering centers and the first clustering centers are determined; a first clustering center having the minimum distance from the respective prior clustering center is identified; and a first clustering region corresponding to this first clustering center having the minimum distance from the respective prior clustering center is taken as the second clustering region matched with the prior clustering center.

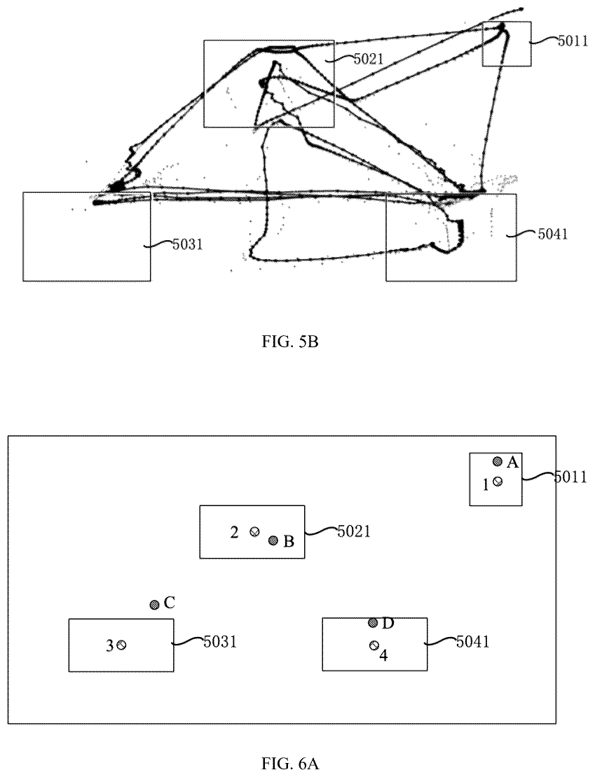

With reference to FIG. 6A, FIG. 6A illustrates the four prior clustering regions corresponding to those in FIG. 5B and the respective prior clustering centers (i.e., prior clustering center 1, prior clustering center 2, prior clustering center 3, and prior clustering center 4) of the four prior clustering regions, as well as four first clustering regions corresponding to the eye movement data shown in FIG. 5B and the respective first clustering centers (i.e., first clustering center A, first clustering center B, first clustering center C, and first clustering center D) of the four first clustering regions. For ease of determining the distances between the first clustering centers and the prior clustering centers, the eye movement data are not shown in FIG. 6A.

As an example, for any one of the given prior clustering regions, the distances between a prior clustering center of the prior clustering region and the respective first clustering centers may be determined, and the first clustering region corresponding to the first clustering center having the minimum distance from the prior clustering center may be determined as the second clustering region for the prior clustering region. For example, for prior clustering region 5011, a first distance between prior clustering center 1 of prior clustering region 5011 and first clustering center A, a second distance between prior clustering center 1 and first clustering center B, a third distance between prior clustering center 1 and first clustering center C, and a fourth distance between prior clustering center 1 and first clustering center D may be determined, respectively. The magnitudes of the first distance, the second distance, the third distance, and the fourth distance are then compared to determine that the minimum distance to prior clustering center 1 is the first distance corresponding to first clustering center A. The first clustering region corresponding to first clustering center A is then taken as the second clustering region corresponding to prior clustering region 5011. Similarly, for prior clustering region 5021, based on the distances between prior clustering region 5021 and all of the first clustering centers, the second clustering region corresponding to prior clustering region 5021 is determined from the four first clustering regions. The same applies to prior clustering region 5031 and prior clustering region 5041, and detailed description thereof is omitted for brevity.

As an example, after the first clustering centers corresponding to the first clustering regions are determined, the first clustering centers may be matched to the prior clustering centers, and then, among all sets of matched pairs, an optimal matching combination in which the sum of the distances between the first clustering centers and the prior clustering centers is minimized may be determined. Based on the correspondence between the first clustering centers and the prior clustering centers in the optimal matching combination, the second clustering region corresponding to each prior clustering region is determined. For example, there are four first clustering centers that may be matched to prior clustering center 1. If first clustering center A is matched to prior clustering center 1, then, for prior clustering center 2, the candidate first clustering centers are the remaining three first clustering centers other than first clustering center A. If first clustering center B is matched to prior clustering center 2, then, for prior clustering center 3, the candidate first clustering centers are the remaining two first clustering centers other than first clustering center A and first clustering center B. If first clustering center C is matched to prior clustering center 3, then prior clustering center 4 is only able to be matched to first clustering center D. In this way, n matching combinations are obtained, where n=4×3×2×1. For each matching combination, the sum of the distances between the four pairs of prior clustering centers and first clustering centers is calculated, and the matching combination having the minimum distance sum is determined as the optimal matching combination. Based on the correspondence in the optimal matching combination, the second clustering region matched to each prior clustering region is determined.

Continuing to refer to FIG. 3A, the description proceeds to operation 104 following operation 103 above.

At operation 104, at least one of the M first clustering regions is merged with the second clustering regions to obtain third clustering regions matched with the prior clustering regions.

In some cases, when the first clustering process is performed on the point set data, if the number of the obtained M first clustering regions is greater than the number of prior clustering regions, there may be situations where a prior clustering region or an expanded prior clustering region includes a plurality of first clustering centers. In such a case, in order to accurately determine the data points that match the prior clustering region, a merging operation is needed.

In some embodiments, with reference to FIG. 3C, operation 104 may be implemented through operations 1041 to 1043 as follows. Operations 1041 to 1043 are also described from the perspective of each individual prior clustering region.

At operation 1041, a range of the prior clustering region is expanded based on a first position deviation threshold corresponding to the target environment to obtain an expanded first prior clustering region.

In embodiments of the present disclosure, due to hardware devices or software algorithms, there is a certain position offset between initial point set data collected for the target environment and objects in the target environment. Accordingly, a first position deviation threshold may be determined based on an empirical deviation amount obtained from historical empirical data, and the prior clustering region may be adjusted based on the first position deviation threshold. A third clustering region matched with the prior clustering region is then determined based on the adjusted prior clustering region.

As an example, if the prior clustering region is represented in the form of a polygon, side lengths of the prior clustering region may be increased by the first position deviation threshold. If the prior clustering region is represented in the form of a circle, a radius or diameter of the prior clustering region may be increased by the first position deviation threshold. The specific expansion manner may be determined based on the representation form of the prior clustering region, and is not particularly limited.

As an example, with reference to FIG. 6B, FIG. 6B illustrates expanded first prior clustering regions obtained by expanding the four prior clustering regions shown in FIG. 6A. Dashed lines indicate the boundaries of the expanded first prior clustering regions.

At operation 1042, clustering center detection is performed on the expanded first prior clustering region to obtain a first detection result.

After each prior clustering region is expanded based on the first position deviation threshold, clustering center detection is performed on the expanded first prior clustering region, i.e., it is detected whether the first clustering center corresponding to each first clustering region falls within the range of the expanded first prior clustering region, thereby obtaining the first detection result.

At operation 1043, in response to the first detection result indicating that the expanded first prior clustering region includes at least one of other clustering centers and a second clustering center, at least one first clustering region corresponding to the at least one of the other clustering centers is merged with the second clustering region corresponding to the second clustering center, to obtain a third clustering region matched with the prior clustering region.

Here, the “other clustering centers” are clustering centers, among the first clustering centers corresponding to the M first clustering regions, other than the second clustering center, and the “second clustering center” is the center of the second clustering region.

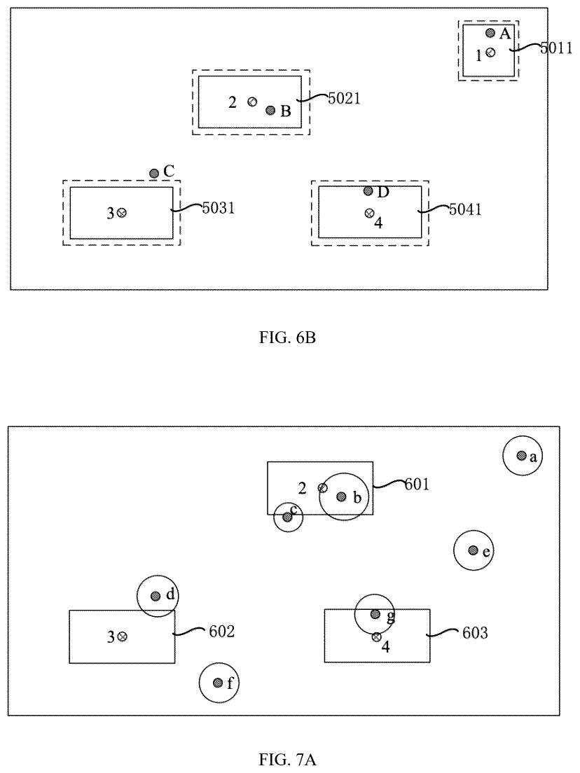

As an example, reference is made to FIG. 7A. FIG. 7A illustrates three pre-calibrated prior clustering regions corresponding to a specified object, and illustrates M first clustering regions obtained by performing a first clustering process on the point cloud data set, where M=7. In FIG. 7A, first clustering region b serves as a second clustering region corresponding to prior clustering region 601, first clustering region d serves as a second clustering region corresponding to prior clustering region 602, and first clustering region g serves as a second clustering region corresponding to prior clustering region 603. If a first position deviation threshold is determined to be 2 cm based on an empirical deviation amount, each side length of the prior clustering regions may be increased by 2 cm so as to expand the prior clustering regions. With reference to FIG. 7B, FIG. 7B illustrates the ranges of the prior clustering regions after expansion based on the first position deviation threshold. As can be seen from FIG. 7B, after performing clustering center detection on the expanded first prior clustering region, the first detection result indicates that the expanded first prior clustering region of prior clustering region 601 includes second clustering center b and first clustering center c (i.e., another clustering center). Second clustering center b is the center of the second clustering region (corresponding to first clustering region b) corresponding to prior clustering region 601, and first clustering center c is the center of first clustering region c. In such a case, the first clustering region c corresponding to first clustering center c may be merged with the second clustering region corresponding to second clustering center b, to obtain a third clustering region matched with prior clustering region 601.

Reference is further made to FIG. 3A, and the description continues following operation 104.

At operation 105, third clustering centers of third clustering regions are used as clustering initial points to perform a second clustering process on the point set data to obtain first target clustering regions matched with the prior clustering regions.

After determining the third clustering region matched with each prior clustering region, the center of the third clustering region is determined as the third clustering center. The third clustering center is used as a clustering initial point to cluster the point set data again, i.e., a second clustering process is performed, to obtain a first target clustering region centered on the third clustering center.

As an example, reference is made to FIG. 7B. After the third clustering region corresponding to prior clustering region 601 is obtained, since the third clustering region includes two clustering regions (second clustering region b and first clustering region c) and the center of the third clustering region is located outside both clustering regions, it is seen that some data points located between the two clustering regions may be data points corresponding to prior clustering region 601. Therefore, the third clustering center of the third clustering region may be used as the clustering initial point to perform the second clustering process, so as to obtain a clustering region centered on the third clustering center as the first target clustering region matched with prior clustering region 601. The data points included in the first target clustering region are data points matched with prior clustering region 601, which may also be understood as data points generated for the specified object corresponding to prior clustering region 601.

By applying the foregoing embodiments, the first clustering process is performed on the point set data of the target environment to obtain the M first clustering regions, second clustering regions respectively pre-matched to the prior clustering regions that have been pre-calibrated for the target environment are determined from the M first clustering regions, and the second clustering regions are merged with at least one first clustering region to obtain third clustering regions matched with the prior clustering regions. Then, the third clustering centers of the third clustering regions are used as the clustering initial points to perform the second clustering process on the point set data, thereby obtaining the first target clustering regions matched with the prior clustering regions. Because, in embodiments of the present disclosure, the point set data is clustered twice, and the second clustering process is performed on the basis of pre-matching and merging of clustering regions obtained from the first clustering process, the second clustering process can yield a more accurate clustering result, such that correlations among data points within the same clustering region are stronger. In this way, the clustering accuracy of the first target clustering regions is improved, thereby improving the matching accuracy between the first target clustering regions and the prior clustering regions.

In some embodiments, when the first detection result indicates that the expanded first prior clustering region excludes other clustering centers, a second clustering process may be performed using a second clustering center of the second clustering region as the clustering initial point on the point set data, so as to obtain a second target clustering region matched with the prior clustering region.

In an actual implementation, reference is made to FIG. 7B. For prior clustering region 603, a first detection result of the expanded first prior clustering region indicates that the expanded first prior clustering region includes only second clustering center g and excludes any other clustering center besides second clustering center g. In such a case, second clustering center g may be directly used as the clustering initial point to perform the second clustering process, to obtain a second target clustering region matched with the prior clustering region. The data points included in the second target clustering region are data points matched with prior clustering region 603. In this case, the second clustering region corresponding to the prior clustering region may be regarded as the third clustering region of the prior clustering region.

In some embodiments, when the first detection result indicates that a second clustering center of the second clustering region is located outside the expanded first prior clustering region, a matching relationship between the second clustering region and the prior clustering region is canceled.

In an actual implementation, reference is made to FIG. 7B. For prior clustering region 602, a first detection result of the expanded first prior clustering region indicates that second clustering center d of second clustering region d, which is matched with prior clustering region 602, is located outside the expanded first prior clustering region. This indicates that the deviation between second clustering region d and prior clustering region 602 has exceeded the empirical deviation amount, and the data points in second clustering region d are not generated for the specified object corresponding to prior clustering region 602. In such a case, the matching relationship between second clustering region d and prior clustering region 602 is directly canceled.

In some embodiments, after expanding each prior clustering region based on the first position deviation threshold, clustering center detection is performed on the expanded first prior clustering regions to obtain the first detection result. Based on the first detection result, it is determined whether the second clustering region corresponding to each prior clustering region is to be subjected to processing such as cancellation of the matching relationship, merging, or retention. According to the processing corresponding to different indications in the first detection result as described above, the third clustering region corresponding to each prior clustering region is obtained, and the third clustering center of the third clustering region is then used as the clustering initial point to perform the second clustering process on the point set data, so as to obtain target clustering regions (the first target clustering regions and the second target clustering regions) corresponding to the respective prior clustering regions.

In some embodiments, after performing the second clustering process on the point set data, a secondary merging process may further be performed on the clustering regions, as described below.

Intermediate clustering regions generated from the second clustering process on the point set data are obtained. Based on a second position deviation threshold corresponding to the target environment, for each prior clustering region, a range of the prior clustering region is expanded to obtain an expanded second prior clustering region. Clustering center detection is performed on the expanded second prior clustering region to obtain a second detection result. When the second detection result indicates that the expanded second prior clustering region includes intermediate clustering centers of a plurality of intermediate clustering regions among the intermediate clustering regions, the plurality of intermediate clustering regions are merged to obtain a merged clustering region. A first target clustering region matched with the prior clustering region is then determined based on the merged clustering region. The second position deviation threshold is greater than the first position deviation threshold, where the first position deviation threshold is a position deviation threshold used when merging at least one of the M first clustering regions with the second clustering regions.

In an actual implementation, during performing the second clustering process on the point set data, other clustering centers other than the third clustering center may appear due to the aggregation of data points in the point set. Therefore, intermediate clustering regions obtained from the second clustering process on the point set data may be acquired and subjected to a merging process.

Specifically, the second position deviation threshold is determined, where the second position deviation threshold is greater than the first position deviation threshold. This is because a merging operation has already been performed once on the second clustering region, and thus a range of an intermediate clustering region obtained during the second clustering process is relatively larger than a range of the second clustering region, or an intermediate clustering center of the intermediate clustering region is relatively further away from the prior clustering center. The prior clustering region is expanded using the second position deviation threshold to obtain an expanded second prior clustering region corresponding to the prior clustering region. Similarly, clustering center detection is performed on the expanded second prior clustering region to obtain the second detection result. When the second detection result indicates that the expanded second prior clustering region includes intermediate clustering centers of a plurality of intermediate clustering regions, the plurality of intermediate clustering regions are merged to obtain a merged clustering region. In this case, the merged clustering region may be directly used as the first target clustering region matched with the prior clustering region, or a fourth clustering center of the merged clustering region is used as a clustering initial point to perform iterative clustering on the point set data until an iterative clustering termination condition is satisfied, thereby obtaining the first target clustering region of the prior clustering region.

In some embodiments, the above “determining the first target clustering region matched with the prior clustering region based on the merged clustering region” may be implemented as follows.

The fourth clustering center of the merged clustering region is used as the clustering initial point, and iterative clustering is performed on the point set data to obtain the first target clustering region matched with the prior clustering region.

The iterative clustering termination condition for the iterative clustering process includes at least one of: a number of clustering iterations reaching a preset number; an overlap rate of data points included in a clustering region obtained in a current clustering iteration and data points included in a clustering region obtained in a previous clustering iteration reaching a preset overlap rate; and a position deviation between a clustering center of the clustering region obtained in the current clustering iteration and a clustering center of the clustering region obtained in the previous clustering iteration being less than a preset deviation.

The fourth clustering center is the center of the merged clustering region. During the iterative clustering process on the point set data, the clustering center of the clustering region obtained in the current clustering iteration may be used as the clustering initial point for a subsequent clustering iteration. When the iterative clustering termination condition is satisfied, the clustering region obtained in the last clustering iteration is taken as the first target clustering region matched with the prior clustering region.

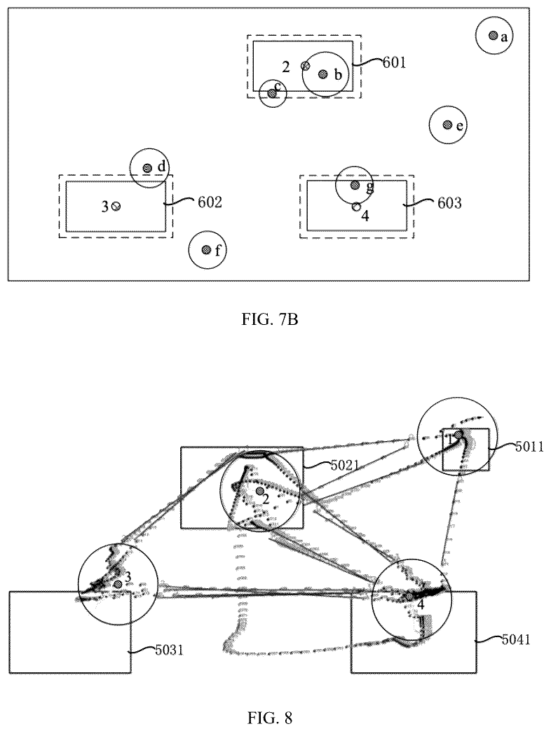

As an example, reference is made to FIG. 8. FIG. 8 is a schematic diagram of target clustering regions obtained after performing the first and second clustering processes on the point set data shown in FIG. 5B, where the target clustering regions include first target clustering regions and second target clustering regions. In FIG. 8, prior clustering region 5011 matches target clustering region 1, prior clustering region 5021 matches target clustering region 2, prior clustering region 5031 matches target clustering region 3, and prior clustering region 5041 matches target clustering region 4.

In a particular embodiment, in order to address the impact of small-range, random, omni-directional deviations around expected positions in eye movement data acquired by an eye tracker, embodiments of the present disclosure may perform clustering and region matching on the eye movement data using the above region matching method, thereby reducing negative effects caused by data deviation and improving the matching accuracy between the eye movement data and the expected positions.

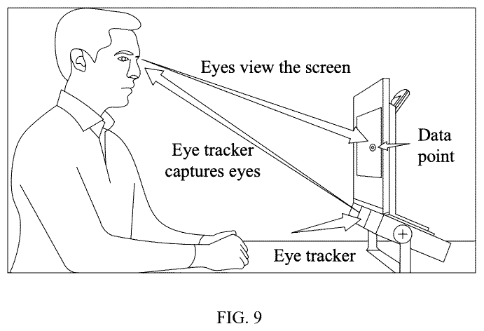

As shown in FIG. 9, the eye tracker is disposed below a screen and is inclined upward to capture images of human eyes. When human eyes are viewing the screen, the position being gazed on the screen is able to be obtained via the eye tracker. However, due to the inherent accuracy of the eye tracker, a deviation may exist between an eye gaze position (eye movement data) acquired by the eye tracker and an actual gaze position.

Taking FIG. 4A as an example, it is assumed that the screen shown in FIG. 9 displays the image shown in FIG. 4A, and the positions and sizes of the four objects (specified objects) in FIG. 4A are known. When human eyes view the screen for a period of time, point set data of positions on the screen viewed by the human eyes, i.e., eye movement data, is able to be obtained through the eye tracker. For example, if a frame rate of the eye tracker is 120 Hz, 120 data points will be obtained per second by the eye tracker without considering cases in which the eyes move out of the screen range. As the human eyes move over a period of time, a sequence of data points along the movement path may be obtained, yielding initial eye movement data as shown in FIG. 5A.

As can be readily seen from FIG. 5A, although the human eyes view the object in the lower-left corner when viewing FIG. 4A on the screen, the acquired eye movement data are overall shifted upward, and the eye movement data in the lower-right corner also exhibit a certain degree of random jitter and deviation, falling outside the range of the actually expected prior clustering region 5041. That is, there is a problem of data deviation between the actually acquired initial eye movement data and the expected data distribution.

To determine which data points in FIG. 5A are generated when the human eyes view the object within the corresponding prior clustering region, it is desired to perform clustering and region matching on such initial point set data that include jitter and random deviation.

First, the initial point set data may be subjected to de-jittering, i.e., position smoothing.

As an example, eye movement data captured by the eye tracker over a specified time period may be acquired. For eye movement data having timing information, the data points are ordered according to their timing sequences, and multi-frame smoothing is applied multiple times to remove jitter of the data points. The basic concept is to perform position smoothing by using R surrounding data points of each frame data point. Specifically, respective weights are assigned to first initial position information of a current frame initial data point before updating, first updated position information of n surrounding data points among the R surrounding data points that have been subjected to position smoothing, and second initial position information of m surrounding data points among the R surrounding data points that have not yet been subjected to position smoothing, and the position smoothing is then performed on the current frame initial data point by performing a weighted summation on these position information, thereby calculating second updated position information of the current frame initial data point after position smoothing.

A largest weight may be assigned to pre-update data of the current frame initial data point, greater weights may be assigned to already-updated data among the R surrounding data points, and the closer a surrounding data point is to the current frame initial data point, the larger weight may be assigned to its position information. In this way, both initial value jitter and subsequent large amplitude jitter of the data are addressed. Weighting coefficients may be adjusted, and the number of surrounding frames used may also be adjusted. Specifically, a largest weight may be assigned to the first initial position information of the current frame initial data point before position smoothing; for the R related surrounding data points, a larger weight may be assigned to the first updated position information of the n surrounding data points after position smoothing than to the second initial position information of the m surrounding data points before position smoothing; and, among the n surrounding data points, the closer in timing sequence a surrounding data point is to the current frame initial data point, the larger weight may be assigned to the first updated position information corresponding to surrounding data point. In this way, corresponding weights are assigned to the first initial position information, the second initial position information of the m surrounding data points, and the first updated position information of the n surrounding data points, such that a first weight is assigned to the first initial position information, a second weight is assigned to the second initial position information of the m surrounding data points, and a third weight is assigned to the first updated position information of the n surrounding data points, where the first weight is greater than the second weight, and the third weight is greater than the second weight.

As an example, the following equations may be used to calculate the second updated position information of the current frame initial data point after position smoothing. In these equations, P represents an initial data point. A subscript to the lower right of P denotes a timing sequence number of this initial data point, and a superscript to the upper right of P denotes whether pre-update data or post-update data (i.e., data before position smoothing or data after position smoothing) of this initial data point is used. A superscript “new” indicates post-update data, and a superscript “old” indicates pre-update data.

When the timing sequence number of the current frame initial data point is greater than 3, for example, when the current frame initial data point is the 24^{th} frame initial data point, the second updated position information of the 24^{th} frame initial data point may be calculated using the following equation:

$${P}_{24}^{new} = 0.1 * {P}_{21}^{new} + 0.2 * {P}_{22}^{new} + 0.3 * {P}_{23}^{new} + 0.4 * {P}_{24}^{old}$$

where

$${P}_{24}^{new}$$

denotes the second updated position information of the initial data point having a timing sequence number of 24;

$${P}_{21}^{new}$$

denotes the first updated position information (corresponding to a third weight of 0.1) of the initial data point having a timing sequence number of 21;

$${P}_{22}^{new}$$

denotes the first updated position information (corresponding to a third weight of 0.2) of the initial data point having a timing sequence number of 22;

$${P}_{23}^{new}$$

denotes the first updated position information (corresponding to a third weight of 0.3) of the initial data point having a timing sequence number of 23; and

$${P}_{24}^{old}$$

denotes the first initial position information (corresponding to a first weight of 0.4) of the initial data point having a timing sequence number of 24.

The second updated position information of a first frame initial data point may be calculated using the following equation:

$${P}_{1}^{new} = 0.4 * {P}_{1}^{old} + 0.3 * {P}_{2}^{old} + 0.2 * {P}_{3}^{old} + 0.1 * {P}_{4}^{old}$$

where

$${P}_{1}^{new}$$

denotes the second updated position information of the initial data point having a timing sequence number of 1;

$${P}_{1}^{o l d}$$

denotes the first initial position information (corresponding to a first weight of 0.4) of the initial data point having a timing sequence number of 1;

$${P}_{2}^{old}$$

denotes the second initial position information (corresponding to a second weight of 0.3) of the initial data point having a timing sequence number of 2;

$${P}_{3}^{o l d}$$

denotes the second initial position information (corresponding to a second weight of 0.2) of the initial data point having a timing sequence number of 3; and

$${P}_{4}^{o l d}$$

denotes the second initial position information (corresponding to a second weight of 0.1) of the initial data point having a timing sequence number of 4.

The second updated position information of a second frame initial data point may be calculated using the following equation:

$${P}_{2}^{n e w} = 0.3 * {P}_{1}^{n e w} + 0.4 * {P}_{2}^{o l d} + 0.2 * {P}_{3}^{o l d} + 0.1 * {P}_{4}^{o l d}$$

where

$${P}_{2}^{n e w}$$

position information of the initial data point having a timing sequence number of 2;

$${P}_{1}^{n e w}$$

denotes the first updated position information (corresponding to a third weight of 0.3) of the initial data point having a timing sequence number of 1;

$${P}_{2}^{o l d}$$

denotes the first initial position information (corresponding to a first weight of 0.4) of the initial data point having a timing sequence number of 2;

$${P}_{3}^{o l d}$$

denotes the second initial position information (corresponding to a second weight of 0.2) of the initial data point having a timing sequence number of 3; and

$${P}_{4}^{o l d}$$

denotes the second initial position information (corresponding to a second weight of 0.1) of the initial data point having a timing sequence number of 4.

The second updated position information of a third frame initial data point may be calculated using the following equation:

$${P}_{3}^{n e w} = 0.2 * {P}_{1}^{n e w} + 0.3 * {P}_{2}^{n e w} + 0.4 * {P}_{3}^{o l d} + 0.1 * {P}_{4}^{o l d}$$

where

$${P}_{3}^{n e w}$$

denotes the second updated position information of the initial data point having a timing sequence number of 3;

$${P}_{1}^{n e w}$$

denotes the first updated position information (corresponding to a third weight of 0.2) of the initial data point having a timing sequence number of 1;

$${P}_{2}^{n e w}$$

denotes the first updated position information (corresponding to a third weight of 0.3) of the initial data point having a timing sequence number of 2;

$${P}_{3}^{o l d}$$

denotes the first initial position information (corresponding to a first weight of 0.4) of the initial data point having a timing sequence number of 3; and

$${P}_{4}^{o l d}$$

denotes the second initial position information (corresponding to a second weight of 0.1) of the initial data point having a timing sequence number of 4.

For other frames' initial data points, second updated position information after position updating may be calculated according to their timing sequence numbers using corresponding equations analogous to those described above. In particular, each instance of smoothing may be performed as follows: for nth frame data, multi-frame data, including pre-update data of the nth data point, post-update data of the (n−1)th data point, post-update data of the (n−2)th data point, post-update data of the (n−3)th data point, etc., may be combined based on different weights. That is, past data is used for the weighted combination. For the initial data updating, however, future data is used for the weighted combination with different weights, thereby reducing the adverse effect of poor de-jittering in situations where the deviation between the initial data point and position-smoothed data point is relatively large.

Referring to FIG. 5B, FIG. 5B illustrates eye movement data obtained after position smoothing (de-jittering) is performed on the initial eye movement data in FIG. 5A. Even after de-jittering, the eye movement data still exhibit a position deviation relative to the prior clustering regions of the actually viewed objects. Accordingly, all eye movement data may be clustered to obtain aggregation points of the distribution of the eye movement data.

Using four prior clustering regions that are pre-calibrated for the four specified objects shown in FIG. 4A, in an ideal case, most of the eye movement data points would cluster into four regions corresponding to the four prior clustering regions, that is, the number of ideal clustering regions is known. A clustering algorithm such as K-means, K-means++, or a Gaussian mixture model may be used to cluster all eye movement data points. Depending on the actual clustering situation, clustering may be performed on all eye movement data points by using the centers of the prior clustering regions as clustering initial points, or by specifying the number of clustering regions, so as to obtain four first clustering centers (corresponding to four first clustering regions).

As shown in FIG. 6A, respective prior clustering centers corresponding to the prior clustering regions and respective first clustering centers corresponding to the first clustering regions are determined. A distance from a current prior clustering center to any first clustering center is calculated, and a distance from a subsequent current prior clustering center to each remaining first clustering center is calculated, so that each prior clustering center is matched with one first clustering center, and the distance between the first clustering center and the prior clustering center matched with each other is calculated. For example, there are four first clustering centers that may be matched to prior clustering center 1. If first clustering center A is matched to prior clustering center 1, then the candidate first clustering centers for prior clustering center 2 are the remaining three first clustering centers other than first clustering center A. If first clustering center B is matched to prior clustering center 2, then the candidate first clustering centers for prior clustering center 3 are the remaining two first clustering centers other than first clustering centers A and B. If first clustering center C is matched to prior clustering center 3, then prior clustering center 4 is only able to be matched to first clustering center D. In this way, n matching combinations are obtained, where n=4×3×2×1. For each matching combination, a sum of distances between the four pairs of prior clustering centers and first clustering centers is calculated, and an optimal matching combination having the minimum distance sum is determined. Based on the correspondence in the optimal matching combination, corresponding first clustering regions matched with the prior clustering regions are determined, thereby obtaining second clustering regions matched with the prior clustering regions.

Subsequently, based on the ranges of the prior clustering regions and an offset amount of the eye movement data, the first clustering regions matched with the prior clustering regions are filtered, where the offset amount is an empirical offset amount determined from historical data of the eye tracker. An appropriate first position deviation threshold is determined based on the offset amount of the eye tracker, and each prior clustering region is expanded according to the first position deviation threshold to obtain the expanded first prior clustering regions. Clustering center detection is performed on each expanded first prior clustering region to obtain a first detection result.

Based on the first detection result, it is determined whether a second clustering center of a second clustering region matched with a prior clustering region is located within the corresponding expanded first prior clustering region. Any second clustering center located outside the corresponding expanded first prior clustering region is deleted, i.e., the matching relationship between the second clustering region corresponding to this second clustering center and the corresponding prior clustering region is canceled. Here, the second clustering center being located outside the range of the corresponding expanded first prior clustering region indicates that a distance between the second clustering center and the corresponding prior clustering center exceeds a certain distance threshold. In other words, an actual position of the specified object corresponding to the prior clustering region is too far from the eye movement data points in the second clustering region corresponding to the second clustering center, and thus the eye movement data in this second clustering region is not generated in response to viewing this specified object, and the matching relationship is therefore canceled. In this case, after canceling the matching relationship between the second clustering region and the prior clustering region, all eye movement data points in this second clustering region may also be deleted and excluded from subsequent clustering. It is assumed that the number of such second clustering regions whose matching relationships are canceled according to this detection result is x.

According to the first detection result, it is determined that the expanded first prior clustering region includes the second clustering center of its corresponding second clustering region and other clustering centers, where the other clustering centers are clustering centers, among the first clustering centers corresponding to the four first clustering regions, other than the second clustering center. The second clustering region corresponding to the second clustering center is merged with the first clustering region(s) corresponding to the other clustering center(s), so as to obtain a third clustering region corresponding to the prior clustering region. A third clustering center of the third clustering region is then calculated, and a position of the third clustering center is stored. It is assumed that the number of second clustering regions merged according to this detection result is y.

After the above merging and deletion processing, clustering centers corresponding to the prior clustering regions are obtained. These clustering centers are of two types: third clustering centers determined through the merging process, and second clustering centers that are not subjected to any processing. These clustering centers corresponding to the prior clustering regions are used as clustering initial points for a second clustering. A clustering method that uses clustering initial points is then applied to perform a second clustering process on the eye movement data, so as to obtain (4-x-y) intermediate clustering regions. The clustering centers of the intermediate clustering regions undergo small-range movement around their original positions, and clustering centers that result from merged data are more accurate.

The second position deviation threshold is determined, and the intermediate clustering regions are subjected to merging or deletion processing in a manner similar to the operations described above, except that the second position deviation threshold is greater than the first position deviation threshold. After merging or deleting the intermediate clustering regions, target clustering regions corresponding to the prior clustering regions may be directly obtained, or iterative clustering may be further performed until an iterative clustering termination condition is satisfied, thereby obtaining the target clustering regions corresponding to the prior clustering regions. Referring to FIG. 8, FIG. 8 illustrates a visualization result after two clustering operations and region adjustment are performed on the eye movement data. In FIG. 8, rectangular boxes represent the prior clustering regions, which are expected regions of the specified objects, and circular regions represent the target clustering regions, which are actual regions of the eye movement data. Based on the matching results determined as described above, accurate matching is achieved between non-equivalent regions even in the presence of eye movement data offset.

The following continues to describe an exemplary structure of the apparatus 455 for region matching in the environment provided in the embodiments of the present disclosure, the apparatus 455 for region matching in the environment being implemented as the software module. In some embodiments, as shown in FIG. 2, software modules of the apparatus 455 for region matching in the environment stored in the memory 440 may include: an obtaining module 4551, configured to obtain point set data of a target environment, where the point set data includes N data points; a first clustering module 4552, configured to perform a first clustering process on the N data points to obtain M first clustering regions, where each of the M first clustering regions corresponds to a respective one of first clustering centers, each of the M first clustering regions includes P data points, where N, M, and P are positive integers and P≤N; a pre-matching module 4553, configured to determine, from the M first clustering regions, second clustering regions matched with pre-calibrated prior clustering regions; a merging module 4554, configured to merge at least one of the M first clustering regions with the second clustering regions to obtain third clustering regions matched with the prior clustering regions; and a second clustering module 4555, configured to use third clustering centers of the third clustering regions as clustering initial points to perform a second clustering process on the point set data to obtain first target clustering regions matched with the prior clustering regions.

In some embodiments, the first clustering module 4552 is further configured to use prior clustering centers of the prior clustering regions as clustering initial points to perform the first clustering process on the N data points in the point set data to obtain the M first clustering regions; or use a number of the prior clustering regions as a number of clustering regions to perform the first clustering process on the N data points in the point set data to obtain the M first clustering regions, where M is equal to the number of prior clustering regions.

In some embodiments, the pre-matching module 4553 is further configured to: for each prior clustering region of the prior clustering regions, determine distances between a prior clustering center of the prior clustering region and the first clustering centers; and select, from the M first clustering regions, a first clustering region of which a first clustering center having a minimum distance from the prior clustering center of the prior clustering region as a second clustering region matched with the prior clustering region.

In some embodiments, the merging module 4554 is further configured to: for each prior clustering region of the prior clustering regions, expand a range of the prior clustering region based on a first position deviation threshold corresponding to the target environment to obtain an expanded first prior clustering region; perform clustering center detection on the expanded first prior clustering region to obtain a first detection result; and in response to the first detection result indicating that the expanded first prior clustering region includes at least one of other clustering centers and a second clustering center, merge the at least one of the M first clustering regions corresponding to the at least one of other clustering centers with a second clustering region corresponding to the second clustering center to obtain a third clustering region matched with the prior clustering region, where the other clustering centers are centers, among first clustering centers corresponding to the M first clustering regions, other than the second clustering center, and the second clustering center is a center of the second clustering region.

In some embodiments, the apparatus 455 for region matching in the environment further includes a third clustering module, configured to, in response to the first detection result indicating that the expanded first prior clustering region excludes the other clustering centers, use the second clustering center of the second clustering region as a clustering initial point to perform the second clustering process on the point set data to obtain a second target clustering region matched with the prior clustering region.

In some embodiments, the apparatus 455 for region matching in the environment further includes a matching cancellation module, configured to, in response to the first detection result indicating that the second clustering center of the second clustering region is located outside a range of the expanded first prior clustering regions, cancel a matching relationship between the second clustering region and the prior clustering region.

In some embodiments, the second clustering module 4555 is further configured, after performing the second clustering process on the point set data, to: for each prior clustering region of the prior clustering regions, obtain intermediate clustering regions generated by performing the second clustering process on the point set data; expand a range of the prior clustering regions based on a second position deviation threshold corresponding to the target environment to obtain an expanded second prior clustering region; perform clustering center detection on the expanded second prior clustering region to obtain a second detection result; in response to the second detection result indicating that the expanded second prior clustering region includes intermediate clustering centers of a plurality of intermediate clustering regions among the intermediate clustering regions, merge the plurality of intermediate clustering regions to obtain a merged clustering region; and determine a respective one of the first target clustering regions that matches the prior clustering region based on the merged clustering region; where the second position deviation threshold is greater than the first position deviation threshold, and the first position deviation threshold is used when merging the at least one of the M first clustering regions with the second clustering regions.

In some embodiments, the second clustering module 4555 is further configured to use a fourth clustering center of the merged clustering region as a clustering initial point to perform iterative clustering on the point set data to obtain a respective one of the first target clustering regions that matches the prior clustering region; where a condition for terminating the iterative clustering includes at least one of: a number of clustering iterations reaching a preset number, an overlap rate of data points included in a clustering region obtained in a current clustering iteration and data points included in a clustering region obtained in a previous clustering iteration reaching a preset overlap rate, and a position deviation between a clustering center of the clustering region obtained in the current clustering iteration and a clustering center of the clustering region obtained in the previous clustering iteration being less than a preset deviation.

In some embodiments, the obtaining module 4551 is configured to obtain initial point set data generated for the target environment, where the initial point set data includes N initial data points; and perform position smoothing on the N initial data points in the initial point set to obtain the point set data.

In some embodiments, the obtaining module 4551 is further configured to sort the N initial data points based on timing information of each initial data point of the N initial data points; and for each initial data point, perform the following operations: determining R surrounding data points associated with the initial data point based on a result of the sorting, where a timing difference between each of the R surrounding data points and the initial data point is less than a preset threshold; determining n surrounding data points having been subjected to position smoothing and m surrounding data points having not being subjected to position smoothing among the R surrounding data points, where R, m, n are integers and m=R-n; obtaining first initial position information of the initial data point, second initial position information of the m surrounding data points, and first updated position information of the n surrounding data points; performing position smoothing on the initial data point based on the first initial position information, the second initial position information of the m surrounding data points, and the first updated position information of the n surrounding data points to obtain second updated position information of the initial data point; and using second updated position information of each of the N initial data points in the initial point set data as position information of each of the N data points in the point set data.

In some embodiments, the obtaining module 4551 is further configured to: in response to a timing sequence number of the initial data point being greater than a first specified sequence number, determine the R surrounding data points adjacent to and preceding the initial data point based on the result of the sorting; in response to the timing sequence number of the initial data point being greater than a second specified sequence number and less than or equal to the first specified sequence number, determine the n surrounding data points adjacent to and preceding the initial data point and the m surrounding data points adjacent to and following the initial data point based on the result of the sorting; and in response to the timing sequence number of the initial data point being equal to the second specified sequence number, determine the R surrounding data points adjacent to and following the initial data point based on the result of the sorting.

In some embodiments, the obtaining module 4551 is further configured to: obtain a first weight corresponding to the first initial position information, a second weight corresponding to the second initial position information of the m surrounding data points, and a third weight corresponding to the first updated position information of the n surrounding data points, where the first weight is greater than the second weight, and the third weight is greater than the second weight; and perform weighted summation on the first initial position information, the second initial position information of the m surrounding data points, and the first updated position information of the n surrounding data points based on the first weight, the second weight and the third weight to obtain the second updated position information of the initial data point.

Embodiments of the present disclosure provide a computer program product including a computer program or computer-executable instructions, where the computer program or computer-executable instructions is stored in a computer-readable storage medium. A processor of the electronic device 400 reads the computer-executable instructions from the computer-readable storage medium. The processor executes the computer-executable instructions to cause the electronic device 400 to perform the method for region matching in the environment in the embodiments of the present disclosure.

Embodiments of the present disclosure provide a computer-readable storage medium storing computer-executable instructions. The computer-readable storage medium stores computer-executable instructions or a computer program which, when executed by a processor, cause the processor to perform the method for region matching in the environment provided in the embodiments of the present disclosure, for example, the method for region matching in the environment illustrated in FIG. 3A.

In some embodiments, the computer-readable storage medium may be a memory such as random access memory (RAM), read-only memory (ROM), flash memory, magnetic surface memory, optical disc, or compact disc read-only memory (CD-ROM), or may be any device including any one of the foregoing memories or any combination thereof.

In some embodiments, the computer-executable instructions may take the form of a program, software, software module, script, or code, written in any form of programming language (including compiled or interpreted languages, or declarative or procedural languages), and may be deployed in any form, including being deployed as a stand-alone program or being deployed as a module, component, subroutine, or other unit suitable for use in a computing environment.

For example, the computer-executable instructions may, but not necessarily, correspond to files in a file system, and may be stored in a portion of a file that stores other programs or data, e.g., one or more scripts in a hypertext markup language (HTML) document, or may be stored in a single file dedicated to the program under discussion, or may be stored in multiple coordinated files (e.g., files that store one or more modules, subprograms, or portions of code).

As an example, the computer-executable instructions may be deployed for execution on an electronic device, may be deployed for execution on a plurality of electronic devices located at one site, or may be deployed for execution on a plurality of electronic devices distributed across a plurality of sites and interconnected via a communication network.

Applying the above embodiments, a first clustering process is performed on the point set data of the target environment to obtain M first clustering regions. Corresponding second clustering regions are pre-matched from the M first clustering regions for the prior clustering regions pre-calibrated for the target environment. The second clustering regions and at least one first clustering region are then merged to obtain the third clustering regions matched with the prior clustering regions. Subsequently, the third clustering centers of the third clustering regions are used as the clustering initial points to perform the second clustering process on the point set data, so as to obtain first target clustering regions matched with the prior clustering regions. Since the embodiments of the present disclosure perform two clustering processes on the point set data, and the second clustering process is performed based on pre-matching and merging of the clustering regions obtained from the first clustering process, the second clustering process yields a more accurate clustering result, which enhances the correlation among data points within the same clustering region, thereby improving the clustering accuracy of the first target clustering regions and, consequently, improving the matching accuracy between the first target clustering regions and the prior clustering regions.

The above description is merely illustrative of embodiments of the present disclosure and is not intended to limit the protection scope of the present disclosure. Any modifications, equivalent substitutions, and improvements made within the spirit and scope of the present disclosure are intended to be included within the protection scope of the present disclosure.

What is claimed is:

1. A method for region matching in an environment, comprising:
obtaining point set data of a target environment, wherein the point set data includes N data points;
performing a first clustering process on the N data points to obtain M first clustering regions, wherein each of the M first clustering regions corresponds to a respective one of first clustering centers, and each of the M first clustering regions includes P data points, wherein N, M, and P are positive integers and P≤N;
determining, from the M first clustering regions, second clustering regions matched with prior clustering regions that are pre-calibrated;
merging at least one of the M first clustering regions with the second clustering regions to obtain third clustering regions matched with the prior clustering regions; and
using third clustering centers of the third clustering regions as clustering initial points to perform a second clustering process on the point set data to obtain first target clustering regions matched with the prior clustering regions.

2. The method of claim 1, wherein performing the first clustering process on the N data points to obtain the M first clustering regions includes:
using prior clustering centers of the prior clustering regions as clustering initial points to perform the first clustering process on the N data points in the point set data to obtain the M first clustering regions.

3. The method of claim 1, wherein performing the first clustering process on the N data points to obtain the M first clustering regions includes:
using a number of the prior clustering regions as a number of clustering regions to perform the first clustering process on the N data points in the point set data to obtain the M first clustering regions, wherein M is equal to the number of prior clustering regions.

4. The method of claim 1, wherein determining, from the M first clustering regions, the second clustering regions matched with the prior clustering regions includes:
for each prior clustering region of the prior clustering regions,
determining distances between a prior clustering center of the prior clustering region and the first clustering centers; and
selecting, from the M first clustering regions, a first clustering region of which a first clustering center having a minimum distance from the prior clustering center of the prior clustering region as a second clustering region matched with the prior clustering region.

5. The method of claim 1, wherein merging at least one of the M first clustering regions with the second clustering regions to obtain the third clustering regions matched with the prior clustering regions includes:
for each prior clustering region of the prior clustering regions,
expanding a range of the prior clustering region based on a first position deviation threshold corresponding to the target environment to obtain an expanded first prior clustering region;
performing clustering center detection on the expanded first prior clustering region to obtain a first detection result; and
in response to the first detection result indicating that the expanded first prior clustering region includes at least one of other clustering centers and a second clustering center, merging the at least one of the M first clustering regions corresponding to the at least one of other clustering centers with a second clustering region corresponding to the second clustering center to obtain a third clustering region matched with the prior clustering region, wherein the other clustering centers are centers, among first clustering centers corresponding to the M first clustering regions, other than the second clustering center, and the second clustering center is a center of the second clustering region.

6. The method of claim 5, wherein in response to the first detection result indicating that the expanded first prior clustering region excludes the other clustering centers, the method further includes:
using the second clustering center of the second clustering region as a clustering initial point to perform the second clustering process on the point set data to obtain a second target clustering region matched with the prior clustering region.

7. The method of claim 5, wherein in response to the first detection result indicating that the second clustering center of the second clustering region is located outside a range of the expanded first prior clustering region, the method further includes:
cancelling a matching relationship between the second clustering region and the prior clustering region.

8. The method of claim 1, wherein, after performing the second clustering process on the point set data, the method further includes:
for each prior clustering region of the prior clustering regions,
obtaining intermediate clustering regions generated by performing the second clustering process on the point set data;
expanding a range of the prior clustering region based on a second position deviation threshold corresponding to the target environment to obtain an expanded second prior clustering region;
performing clustering center detection on the expanded second prior clustering region to obtain a second detection result;
in response to the second detection result indicating that the expanded second prior clustering region includes intermediate clustering centers of a plurality of intermediate clustering regions among the intermediate clustering regions, merging the plurality of intermediate clustering regions to obtain a merged clustering region; and
determining a respective one of the first target clustering regions that matches the prior clustering region based on the merged clustering region;
wherein the second position deviation threshold is greater than the first position deviation threshold, and the first position deviation threshold is used when merging the at least one of the M first clustering regions with the second clustering regions.

9. The method of claim 8, wherein determining the respective one of the first target clustering regions that matches the prior clustering region based on the merged clustering region includes:
using a fourth clustering center of the merged clustering region as a clustering initial point to perform iterative clustering on the point set data to obtain the respective one of the first target clustering regions that matches the prior clustering region;
wherein a condition for terminating the iterative clustering includes at least one of: a number of clustering iterations reaching a preset number, an overlap rate of data points included in a clustering region obtained in a current clustering iteration and data points included in a clustering region obtained in a previous clustering iteration reaching a preset overlap rate, and a position deviation between a clustering center of the clustering region obtained in the current clustering iteration and a clustering center of the clustering region obtained in the previous clustering iteration being less than a preset deviation.

10. The method of claim 1, wherein obtaining the point set data of the target environment includes:
obtaining initial point set data generated for the target environment, wherein the initial point set data includes N initial data points; and
performing position smoothing on the N initial data points in the initial point set data to obtain the point set data.

11. The method of claim 10, wherein performing the position smoothing on the N initial data points in the initial point set data includes:
sorting the N initial data points based on timing information of each initial data point of the N initial data points; and
for each initial data point, performing the following operations:
determining R surrounding data points associated with the initial data point based on a result of the sorting, wherein a timing difference between each of the R surrounding data points and the initial data point is less than a preset threshold;
determining n surrounding data points having been subjected to position smoothing and m surrounding data points having not being subjected to position smoothing among the R surrounding data points, wherein R, m, n are integers and m=R−n;
obtaining first initial position information of the initial data point, second initial position information of the m surrounding data points, and first updated position information of the n surrounding data points;
performing position smoothing on the initial data point based on the first initial position information, the second initial position information of the m surrounding data points, and the first updated position information of the n surrounding data points to obtain second updated position information of the initial data point; and
using second updated position information of each of the N initial data points in the initial point set data as position information of each of the N data points in the point set data.

12. The method of claim 11, wherein determining the R surrounding data points associated with the initial data point based on the result of the sorting includes:
in response to a timing sequence number of the initial data point being greater than a first specified sequence number, determining the R surrounding data points adjacent to and preceding the initial data point based on the result of the sorting;
in response to the timing sequence number of the initial data point being greater than a second specified sequence number and less than or equal to the first specified sequence number, determining the n surrounding data points adjacent to and preceding the initial data point and the m surrounding data points adjacent to and following the initial data point based on the result of the sorting; and
in response to the timing sequence number of the initial data point being equal to the second specified sequence number, determining the R surrounding data points adjacent to and following the initial data point based on the result of the sorting.

13. The method of claim 11, wherein performing the position smoothing on the initial data point based on the first initial position information, the second initial position information of the m surrounding data points, and the first updated position information of the n surrounding data points to obtain the second updated position information of the initial data point includes:
obtaining a first weight corresponding to the first initial position information, a second weight corresponding to the second initial position information of the m surrounding data points, and a third weight corresponding to the first updated position information of the n surrounding data points, wherein the first weight is greater than the second weight, and the third weight is greater than the second weight; and
performing a weighted summation on the first initial position information, the second initial position information of the m surrounding data points, and the first updated position information of the n surrounding data points based on the first weight, the second weight and the third weight to obtain the second updated position information of the initial data point.

14. An electronic device, comprising:
a memory, configured to store computer-executable instructions; and
a processor, configured, when executing the computer-executable instructions stored in the memory, to implement a method for region matching in an environment, wherein the method includes:
obtaining point set data of a target environment, wherein the point set data includes N data points;
performing a first clustering process on the N data points to obtain M first clustering regions, wherein each of the M first clustering regions corresponds to a respective one of first clustering centers, and each of the M first clustering regions includes P data points, wherein N, M, and P are positive integers and PSN;
determining, from the M first clustering regions, second clustering regions matched with prior clustering regions that are pre-calibrated;
merging at least one of the M first clustering regions with the second clustering regions to obtain third clustering regions matched with the prior clustering regions; and
using third clustering centers of the third clustering regions as clustering initial points to perform a second clustering process on the point set data to obtain first target clustering regions matched with the prior clustering regions.

15. The electronic device of claim 14, wherein performing the first clustering process on the N data points to obtain the M first clustering regions includes:
using prior clustering centers of the prior clustering regions as clustering initial points to perform the first clustering process on the N data points in the point set data to obtain the M first clustering regions.

16. The electronic device of claim 14, wherein performing the first clustering process on the N data points to obtain the M first clustering regions includes:
using a number of the prior clustering regions as a number of clustering regions to perform the first clustering process on the N data points in the point set data to obtain the M first clustering regions, wherein M is equal to the number of prior clustering regions.

17. A non-transitory computer-readable storage medium storing computer-executable instructions or a computer program, wherein the computer-executable instructions or the computer program, when executed by a processor, implement a method for region matching in an environment, wherein the method includes:
obtaining point set data of a target environment, wherein the point set data includes N data points;
performing a first clustering process on the N data points to obtain M first clustering regions, wherein each of the M first clustering regions corresponds to a respective one of first clustering centers, and each of the M first clustering regions includes P data points, wherein N, M, and P are positive integers and P≤N;
determining, from the M first clustering regions, second clustering regions matched with prior clustering regions that are pre-calibrated;
merging at least one of the M first clustering regions with the second clustering regions to obtain third clustering regions matched with the prior clustering regions; and
using third clustering centers of the third clustering regions as clustering initial points to perform a second clustering process on the point set data to obtain first target clustering regions matched with the prior clustering regions.

18. The non-transitory computer-readable storage medium of claim 17, wherein performing the first clustering process on the N data points to obtain the M first clustering regions includes:
using prior clustering centers of the prior clustering regions as clustering initial points to perform the first clustering process on the N data points in the point set data to obtain the M first clustering regions.

19. The non-transitory computer-readable storage medium of claim 17, wherein performing the first clustering process on the N data points to obtain the M first clustering regions includes:
using a number of the prior clustering regions as a number of clustering regions to perform the first clustering process on the N data points in the point set data to obtain the M first clustering regions, wherein M is equal to the number of prior clustering regions.

20. A computer program product comprising computer-executable instructions or a computer program, wherein the computer-executable instructions or the computer program, when executed by a processor, implement the method according to claim 1.
